(19) United States
(12) Patent Application Publication
(10) Pub. No.: US 2016/0086210 A1
(43) Pub. Date: Mar. 24, 2016

(54) METHOD FOR PROVIDING SHOPPING MALL AND SERVER SYSTEM THEREFORE

(71) Applicant: Jeong Gab LEE, Seoul (KR)

(72) Inventor: Jeong Gab LEE, Seoul (KR)

(21) Appl. No.: 14/953,441

(22) Filed: Nov. 30, 2015

Related U.S. Application Data
(63) Continuation of application No. 12/609,061, filed on Oct. 30, 2009, now abandoned.

(30) Foreign Application Priority Data
May 27, 2009 (KR) 10-2009-0046554

(51) Int. Cl. G06Q 30/02

(52) U.S. Cl. CPC G06Q 30/0212

(57) ABSTRACT

A method for providing a shopping mall is provided. The method includes receiving a request for a multi-party goods sale contest, proceeding with the multi-party goods sale contest when the contest is established in response to the request, analyzing a contest result in consideration of a sale record after a predetermined time lapses, determining a goods sale rank of the plurality of sellers based on the analyzed sale result, and giving different benefits to buyers purchasing goods of the plurality of sellers according to the determined sale rank.

### CROSS-REFERENCE TO RELATED APPLICATION

This application is a continuation of U.S. patent application Ser. No. 12/609,061, filed on Oct. 30, 2009, which claims the benefit under 35 U.S.C. §119(a) of Korean Patent Application No. 10-2009-0046554, filed on May 27, 2009, the disclosure of which is incorporated herein in its entirety by reference.

### BACKGROUND

1. Field

The present invention relates to a method for providing a shopping mall, and more particularly, to a method for providing a game-type shopping mall and a server system for providing a shopping mall.

2. Description of Related Art

Recently, interest in the Internet has increased explosively. Accordingly, besides being a simple subsidiary communication tool, the Internet is evolving into a commercial business space. The development of Internet communications and electronic commerce has given rise to Internet shopping malls.

### SUMMARY OF THE INVENTION

The present invention is directed to a method for providing a shopping mall that supports at least one of 1:1 contest and a multi-party goods sale contest among at least three sellers, and a server system for providing a shopping mall.

According to an aspect of the present invention, there is provided a method for providing a shopping mall including: receiving a request for a goods sale contest, analyzing a contest result in consideration of a sale record after a predetermined time lapses when the goods sale contest is established and proceeds in response to the request, determining a winning seller based on the analyzed contest result, and giving benefits to buyers purchasing goods of the winning seller.

According to another aspect of the present invention, there is provided a system for providing a shopping mall, including: a controller for receiving a request for a goods sale contest, analyzing a contest result in consideration of a sale record after a predetermined time lapses when the goods sale contest is established and proceeds in response to the request, determining a winning seller based on the contest result, and giving benefits to buyers purchasing goods of the winning seller, and a display unit for displaying a situation of the goods sale contest in real time.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a block diagram of a system for providing a shopping mall according to an exemplary embodiment of the present invention;

FIG. 2 is a schematic block diagram of a server for providing a shopping mall according to an exemplary embodiment of the present invention;

FIG. 3 is a flowchart of a method for providing a shopping mall according to an exemplary embodiment of the present invention;

FIG. 4 schematically illustrates a category-specific goods sale contest according to an exemplary embodiment of the present invention;

FIG. 5 illustrates a screen for a request for a goods sale contest in the form of a written challenge according to an exemplary embodiment of the present invention;

FIG. 6 illustrates a screen for a request for a goods sale contest by a recommender according to an exemplary embodiment of the present invention;

FIG. 7 illustrates a 1:1 goods sale contest according to an exemplary embodiment of the present invention;

FIG. 8 illustrates further information of goods for sale according to an exemplary embodiment of the present invention;

FIG. 9 illustrates a community in which goods sale information is exchanged according to an exemplary embodiment of the present invention;

FIG. 10 illustrates a result of a goods sale contest according to an exemplary embodiment of the present invention;

FIG. 11 illustrates a screen for management of a contest record in a goods sale contest according to an exemplary embodiment of the present invention;

FIG. 12 illustrates a screen for relaying a goods sale contest live in real time according to an exemplary embodiment of the present invention;

FIG. 13 illustrates a screen for management of a contest record for each person according to an exemplary embodiment of the present invention;

FIG. 14 illustrates a screen for broadcasting a 1:1 goods sale contest in TV home shopping service according to an exemplary embodiment of the present invention;

FIG. 15 illustrates a screen for broadcasting a multi-party goods sale contest in an Internet shopping service according to an exemplary embodiment of the present invention; and

FIG. 16 illustrates a screen for broadcasting a multi-party goods sale contest in a TV home shopping service according to an exemplary embodiment of the present invention.

### DETAILED DESCRIPTION OF EMBODIMENTS

The foregoing and other objects, features, and advantages of the invention are apparent from the following detailed description taken in conjunction with the accompanying drawings

Exemplary embodiments of the present invention capable of achieving the above-described object will be described with reference to the accompanying drawings. The configuration and operation of the present invention shown in and described with reference to the drawings is for illustration purposes only.

Terms used herein are general terms widely used for functions in the present invention, but may be selected according to an intension of those skilled in the art, practice, or new technology. In a specific case, the terms may be selected by the applicant, in which meanings of the selected terms will be described in detailed description of the present invention. It is to be noted that the terms used herein are not simply determined but according to their meanings and the content of the present invention.

Throughout this disclosure, a shopping mall refers to a building-less shopping space that displays and sells goods. Shopping malls may include Internet shopping malls implemented in a virtual world on a computer communication network. The shopping malls may include home shopping services implemented through a broadcasting cable or a telephone line.

Throughout this disclosure, a goods sale contest refers to a shopping mall operating scheme established by a request for the goods sale contest and an acceptance of the request. The goods sale contest may include a 1:1 goods sale contest or a multi-party goods sale contest involving at least three sellers. For the 1:1 goods sale contest, a sale result may be analyzed to determine a winning seller. Various benefits such as a winning bonus may be given to the winning seller and buyers purchasing the goods of the winning seller. Meanwhile, for the multi-party goods sale contest, a sale result may be analyzed to determine a goods sale rank. Different benefits corresponding to a sale rank of the sellers may be given to the sellers and buyers purchasing the goods.

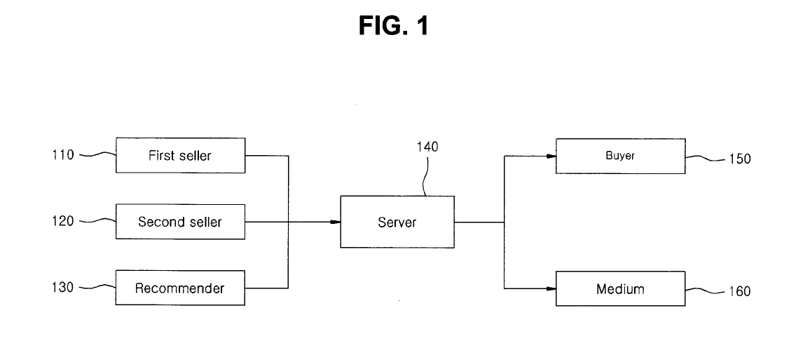

FIG. 1 is a block diagram of a system for providing a shopping mall according to an exemplary embodiment of the present invention. A 1:1 goods sale contest according to an exemplary embodiment will be described and then a multi-party goods sale contest will be described.

As shown in FIG. 1, a system for providing a shopping mall according to the present invention may include a first seller 110, a second seller 120, a recommender 130, a server 140, a buyer 150, and a medium 160.

The first seller 110 and the second seller 120 may sell goods or services in the shopping mall. The first seller 110 or the second seller 120 may request a sale contest to the server 140. For example, the first seller 110 requests the sale contest to the server 140. In this case, the first seller 110 may inform the server 140 of a brand name of a desired contestant or goods types for the sale contest. The server 140 may search for the contestant for the sale contest requested by the first seller 110, based on the brand name or the goods types. In this case, when the second seller 120 is searched as the contestant for the sale contest, the server 140 may propose the goods sale contest requested by the first seller 110 to the second seller 120. When the second seller 120 accepts the proposal, the first seller 110 and the second seller 120 may proceed with the goods sale contest.

Meanwhile, the goods sale contest may be requested by the recommender 130. Examples of the recommender 130 may include the server 140, the buyer 150 and an ordinary customer. For example, the buyer 150 may recommend a goods sale contest between the first seller 110 and the second seller 120 to the server 140. The first seller 110 and the second seller 120 may be sellers who sell goods with competitive brands or goods with similar specifications. The server 140 proposes the goods sale contest to the first seller 110 and the second seller 120. When the first seller 110 and the second seller 120 accept the proposal, the server 140 proceeds with the goods sale contest. In this case, the server 140 may perform a pros and cons vote for the goods sale contest recommended by the buyer 150, and determine whether to proceed with the goods sale contest based on the vote result. In this case, the contest may further include a multi-party goods sale contest. For example, third and fourth sellers may be added for the multi-party goods sale contest.

The server 140 may mediate the sale contest between the first seller 110 and the second seller 120. The server 140 may mediate the sale contest in real time through the medium 160. The server 140 may transmit the sale contest result to the specific medium 160 for advertisement. The specific medium 160 may include a TV home shopping service, an Internet protocol television (IPTV), Internet user created contents (UCC), a media organization's server, etc. The specific medium may be an on-line or off-line medium.

Thus, when the first seller 110 proposes brands and goods of the second seller 120 to the server 140 for the sale contest and the second seller 120 accepts the proposal through the server 140, the goods sale contest proceeds, such that opinions of both the first seller 110 and the second seller 120 can be reflected. Second, when at least two desired companies or brands are recommended by the server 140, the buyer 150 or an ordinary customer (or a netizen), the server 140 can establish the goods sale contest through a vote, thereby allowing direct participation of the customer.

According to the present invention, the first seller 110 and the second seller 120 can increase advertisement earnings through the medium 160 according to the contest result. The buyer 150 can obtain information on popular goods for sale through the medium 160.

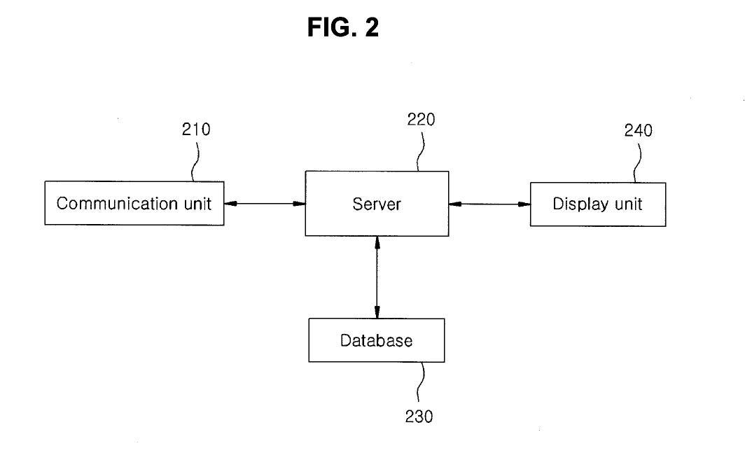

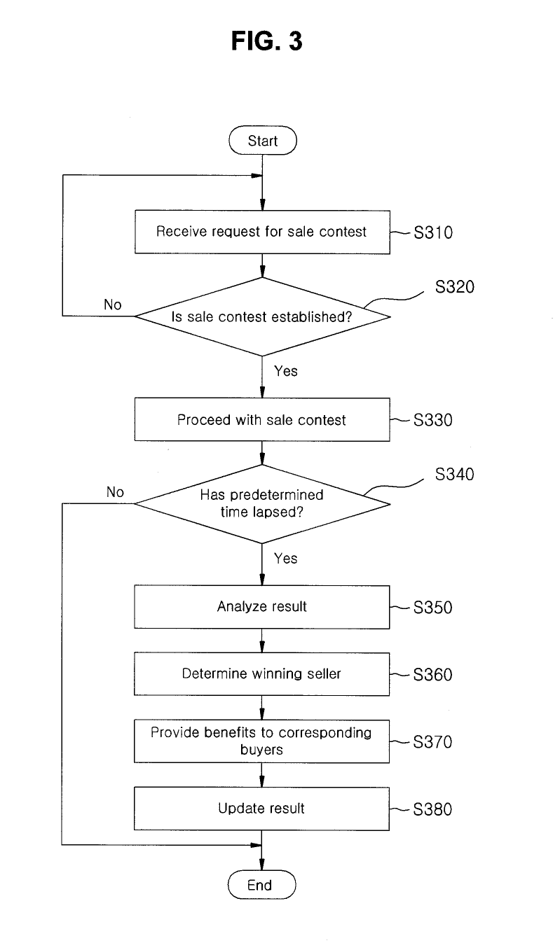

FIG. 2 is a schematic block diagram of a server for providing a shopping mall according to an exemplary embodiment of the present invention, and FIG. 3 is a flowchart of a method for providing a shopping mall according to an exemplary embodiment of the present invention.

As shown in FIG. 2, a shopping-mall server system according to the present invention may include a communication unit 210, a controller 220, a database 230 and a display unit 240.

The communication unit 210 may support communication among the shopping mall server, a seller and a buyer. The communication unit 210 may be automatically connected to a specific medium that advertises a goods sale contest result after the goods sale contest ends. In this case, the specific medium connected via the communication unit 210 may include a TV home shopping service, an IPTV, an Internet UCC, a media organization's server, etc. The specific medium may further include on-line or off-line medium.

The controller 220 receives a request for a goods sale contest. In response to the request, the goods sale contest is established and proceeds between the seller and the buyer. After a predetermined time lapses, the controller 220 analyzes the result of the goods sale contest. In this case, the contest result may be determined according to a sale record. The sale record may include a total goods sale amount or a total goods order amount. The controller 220 may then determine a winning seller based on the analyzed contest result. The winning seller may be provided with a predetermined winning bonus. The controller 220 may control the display unit 240 to display a situation of the goods sale contest in real time. Also, the controller 220 may relay the goods sale contest situation on a specific medium such as a TV home shopping service, an IPTV, or Internet UCC in real time through the communication unit.

The database 230 may store updated contest results under control of the controller 220. Accordingly, the contest results stored in the database 230 may be used to recognize a seller's contest record and a buyer's betting ability.

The display unit 240 may display the contest situation in real time under control of the controller 220. Thus, the goods sale contest situation can be relayed in real time through the display unit 240.

A method for providing a shopping mall according to the present invention as shown in FIG. 3 will now be described with reference to the configuration of the shopping-mall providing server according to the present invention in FIG. 2.

Referring to FIG. 3, the controller 220 of the server system for providing a shopping mall receives a request for a goods sale contest (S310). The controller 220 may directly receive a request for a goods sale contest from at least two sellers, including a first seller and a second seller. Alternatively, the controller 220 may also receive a request for a goods sale contest from a recommender, such as a buyer.

When the sale contest is established, the controller 220 controls to proceed with the sale contest (S320, S330). The controller 220 may mediate a method of sale between the sellers, buyer's purchase, payment, delivery, after-sale service, etc. The controller 220 may proceed with the goods sale contest as a 1:1 contest. The controller 220 may change the contest into a survival consecutive-victory contest or a tournament contest, in which 1:1 contests are consecutively performed. The method of the sale contest may be determined by a requester upon requesting the contest. Alternatively, the sale contest may be determined according to a format for the shopping-mall providing server that is basically provided by the controller 220. The goods contest may be established according to goods categories, such as brand, price, type, and use. The controller 220 may control the display unit 250 to display a situation of the contest in real time. The controller 220 may control to relay the goods sale situation in real time through a specific medium, which is automatically connected to the communication unit 210. The specific medium may include a specific Internet site, a TV home shopping service, an IPTV, an Internet UCC, etc.

After a predetermined contest proceeding time lapses, the controller 220 analyzes the contest result (S340, S350). The contest result may be determined based on a total order amount or a total sale amount.

The controller 220 then determines a winning seller according to the analyzed contest result and provides benefits to buyers purchasing the goods of the winning seller (S360, S370). The benefits may include mileage and reservation of reserve-funds, discounts, coupons, and the like. The controller 220 may further provide a winning bonus to the winning seller. The winning bonus may include a discounted sale commission and an advertisement priority. In this case, the contest result in the 1:1 contest or the survival consecutive-victory contest may be determined as one of a KO victory, a win on points, and a tie. The contest result in the tournament may be determined according to a victory point and a victory percentage.

The controller 220 then updates the contest result and bonus provision content in the database 230 (S380). The contest result and the bonus provision content updated in the database 230 may be used for contest record management.

The controller 220 controls to advertise the contest result using the specific medium automatically connected through the communication unit 210. The specific medium connected through the communication unit 210 may include a TV home shopping service, an IPTV, an Internet UCC, and a media organization's server. Alternatively, the specific medium may include an on-line or off-line medium. The communication unit 210 may support communications such as high speed Internet or wireless Internet.

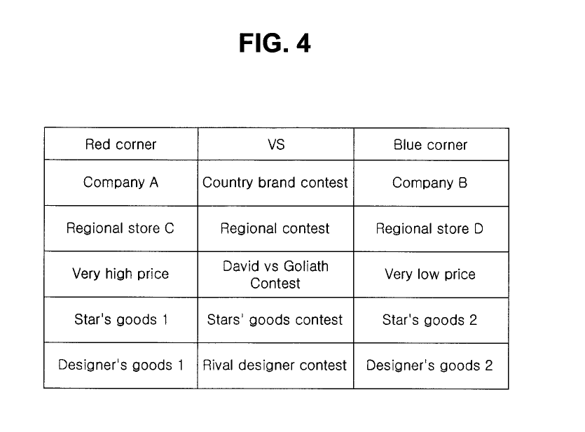

FIG. 4 schematically illustrates a category-specific goods sale contest according to an exemplary embodiment of the present invention.

As shown in FIG. 4, a goods sale contest according to the present invention may be classified according to categories. For example, third and fourth sellers may be added for a multi-party goods sale contest, in addition to the first and second sellers proceeding with the 1:1 goods sale contest. After the multi-party goods sale contest has proceeded for a predetermined time, the controller 220 may analyze the goods sale result to determine a sale rank of the plurality of sellers proceeding with the multi-party goods sale contest. The controller 220 may then provide different benefits to buyers purchasing goods of the plurality of sellers according to the sale rank of the plurality of sellers.

The goods sale contests according to the present invention may be classified according to categories. For example, the goods sale contests may be classified according to ideas, country brands, regions, prices, functions, and the like. The goods sale category may be determined according to request content written by a requester upon requesting the goods sale contest. The goods sale category may be determined by a basic format for the server system for providing a shopping mall.

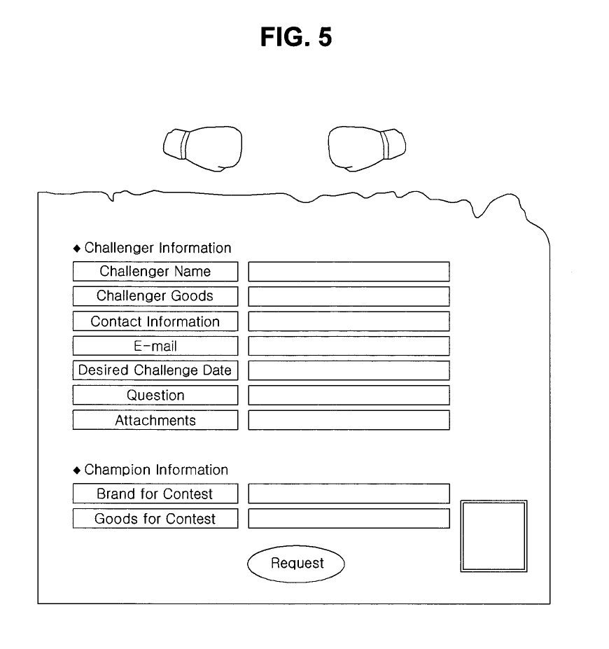

FIG. 5 illustrates a screen for a request for a goods sale contest in the form of a written challenge according to an exemplary embodiment of the present invention.

As shown in FIG. 5, a goods sale contest according to the present invention may be requested directly by a seller. The seller may request a goods sale contest through a request in the form of a written challenge. For example, the seller writes the request for a goods sale contest in the form of a written challenge, in which a first seller desiring to sell goods writes his or her name, goods name, contact information, and the like to the written challenge. The first seller further writes goods of desired brands or categories for the goods sale contest. A shopping-mall providing server managing and mediating the goods sale contest then searches for goods corresponding to the brands or categories for the contest, and proposes the goods sale contest to a second seller selling the searched goods. When the second seller accepts the proposal, the goods sale contest may be established. In other exemplary embodiments, when the first seller writes only his or her name, goods name, and contact information to the written challenge, the shopping-mall providing server may directly analyze a category and a brand based on the goods name of the first seller to search for the second seller.

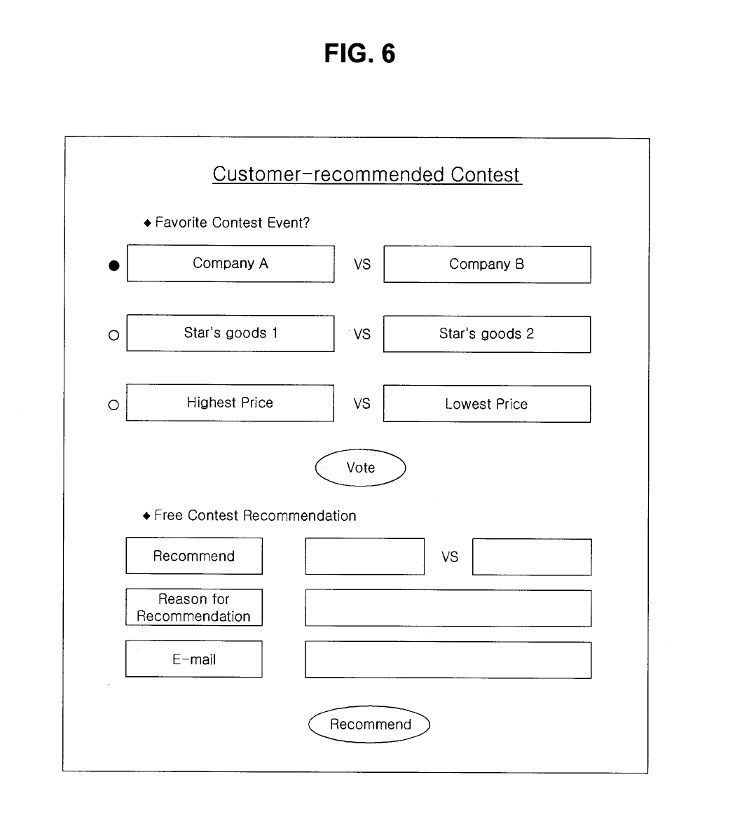

FIG. 6 illustrates a screen for a request for a goods sale contest by a recommender according to an exemplary embodiment of the present invention.

As shown in FIG. 6, a goods sale contest according to the present invention may be requested by a recommender. The recommender may be a first seller desiring the goods sale contest. Alternatively, the recommender may be a shopping-mall providing server or a customer (such as a buyer and an ordinary customer). For example, the shopping-mall providing server may regularly vote for a method of a goods sale contest. The goods sale contest may proceed in the method for the goods sale contest determined by the vote. In this case, the method for the goods sale contest may include a brand contest, a stars' goods contest or a product-specific contest. The shopping-mall providing server may receive a goods sale contest recommendation from the recommender in real time. Thus, the shopping-mall providing server can receive a request for a sale contest for a plurality of goods from the customer.

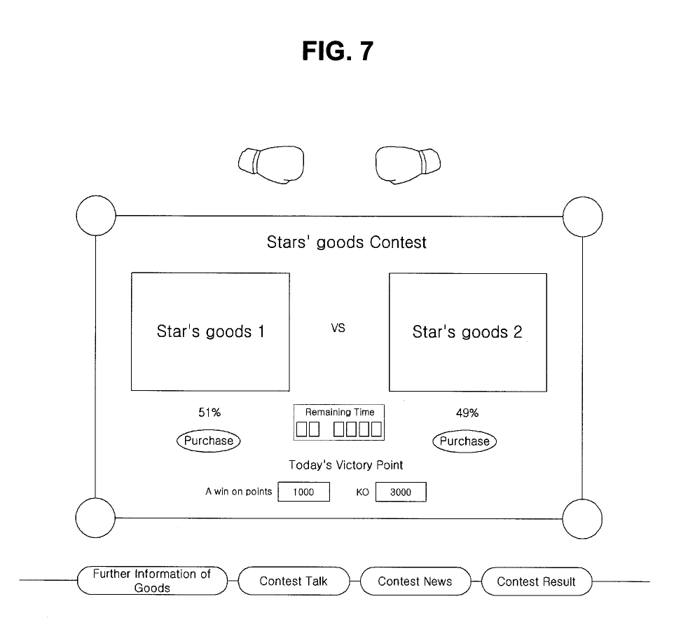

FIG. 7 illustrates a 1:1 goods sale contest according to an exemplary embodiment of the present invention.

As shown in FIG. 7, a goods sale contest may be performed as a 1:1 contest. The 1:1 goods sale contest may be established according to categories of goods. A result of the 1:1 goods sale contest may include a win on points, a KO victory by early sell-out, or a tie. The contest result may be determined according to a total order amount or a total sale amount. The contest result may be determined as the win on points for different total order amounts or different total sale amounts, the KO victory for early sell-out, or the tie for the same order amounts or the same total sale amounts.

The winning seller in the 1:1 goods sale contest may be provided with a winning bonus. The winning bonus may include discounted sale commission and an advertisement priority. For example, a different rate of reservation of reserve-funds or a different commission discount rate may be applied according to the contest result. For example, the rate may be 1% of price on the average for the win on points and 3% for the KO victory. A penalty may be given to a KO-defeated seller to prevent the seller from participating in the contest during a specific period.

Benefits may be given to buyers purchasing the goods of the winning seller, as well as the winning seller. In this case, the benefits may include mileage and reservation of reserve-funds, discounts, and coupons.

The 1:1 contest may be performed several times to determine a final winning seller weekly or monthly. The final winning seller may be provided with a predetermined additional bonus. In this case, the final winning seller may be determined by a consecutive-victory contest. The consecutive-victory contest may include a tournament contest, a survival consecutive-victory contest, and the like. The consecutive victory contest may further include a consolation game and a return game.

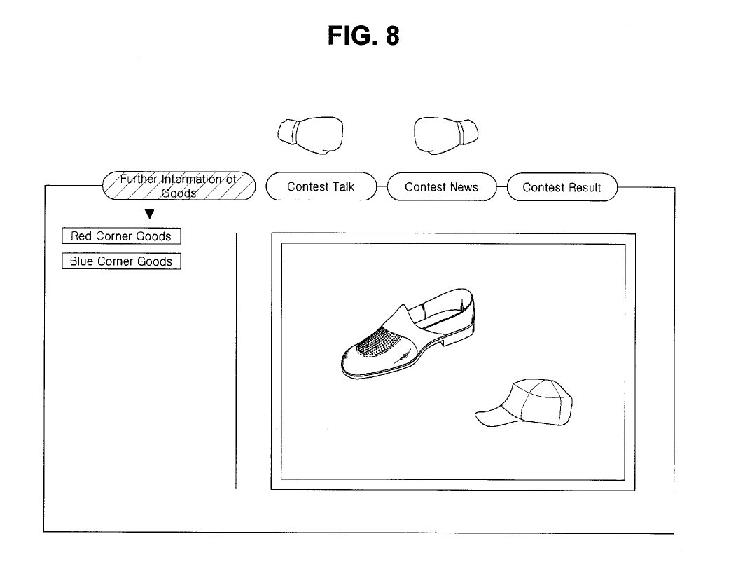

FIG. 8 illustrates further information of goods for sale according to an exemplary embodiment of the present invention.

As shown in FIG. 8, further information of goods for sale according to the present invention may be directly provided by clicking on an icon. For example, in case of a 1:1 goods sale contest, further information of goods of a first seller is displayed by clicking on a button “Red Corner Goods”. Further information of goods of a second seller is displayed by clicking on a button “Blue Corner Goods”. The icons may be modified according to a format for the shopping-mall providing server. Thus, buyers desiring to purchase goods through the shopping-mall providing server can view further information of products by simply clicking on the buttons.

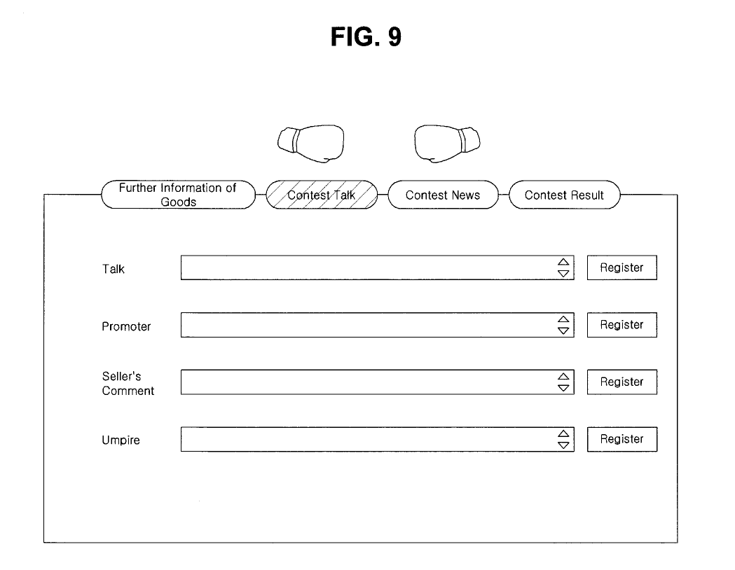

FIG. 9 illustrates a community in which goods sale information is exchanged according to an exemplary embodiment of the present invention.

As shown in FIG. 9, a community according to the present invention enables a seller and a buyer to exchange goods sale information. For example, the community may include a bulletin board that enables buyers to write questions about goods sale or an additional request. The bulletin board may have a function for comments. The community may further include an icon for a moderator that enables the moderator to moderate dishonest acts for the goods sale and warn against antagonistic comments. Thus, the community enables the seller and the buyer to smoothly exchange opinions and perform goods sale. Also, mediation by the moderator enables a fair goods sale contest.

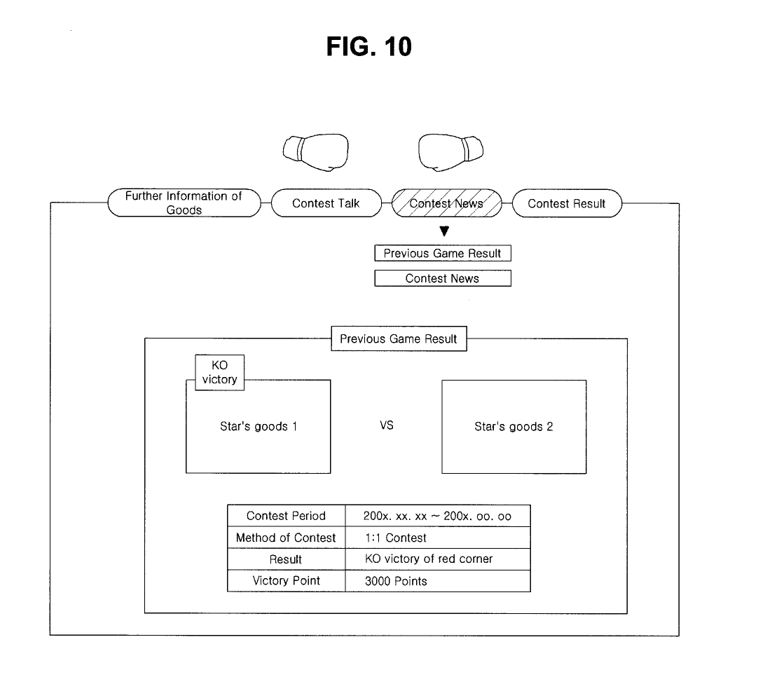

FIG. 10 illustrates a result of a goods sale contest according to an exemplary embodiment of the present invention.

As shown in FIG. 10, a result of a goods sale contest according to the present invention may be indicated on one page. The result may include victory or defeat, contest record, contest record management, and the like. Thus, the customer can refer to results of previous goods sale contests any time he or she likes.

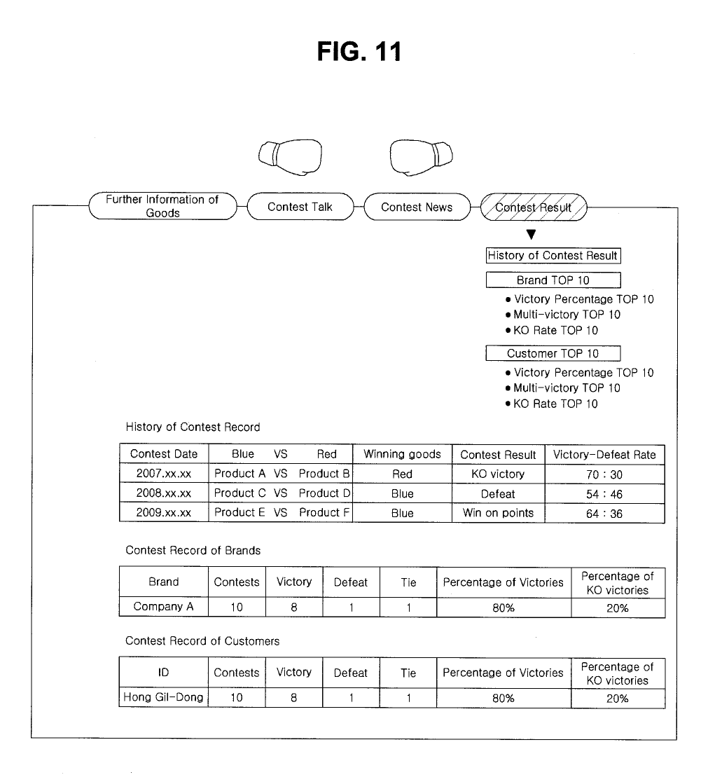

FIG. 11 illustrates a screen for management of a contest record of a goods sale contest according to an exemplary embodiment of the present invention.

As shown in FIG. 11, a contest record of a goods sale contest according to the present invention may be managed according to customers, brands, dates, and categories. The contest record management may include goods sale contest results and bonus provision content. A priority may be given to each seller based on the contest record. For example, the contest record management may be used to determine a rank according to multi-victory, KO, and a victory percentage, and benefits such as an advertisement priority and a discounted commission may be given according to the determined rank.

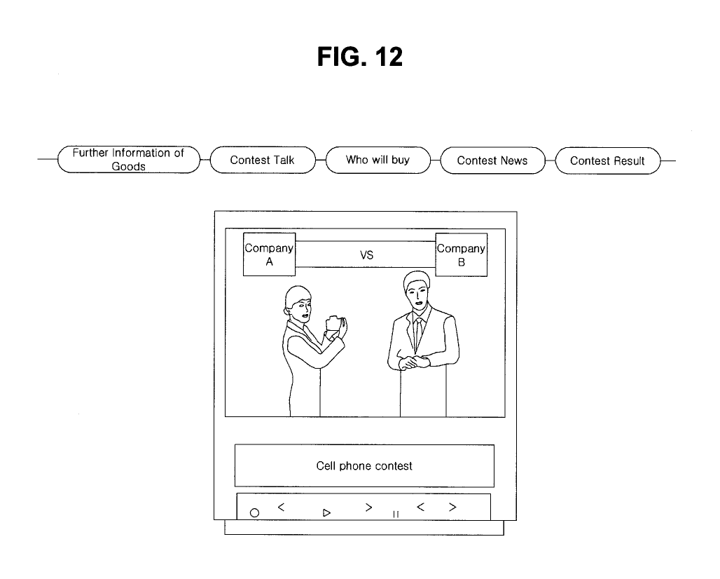

FIG. 12 illustrates a screen for relaying a goods sale contest live in real time according to an exemplary embodiment of the present invention.

As shown in FIG. 12, a situation of the goods sale contest according to the present invention may be relayed through a specific medium in real time. The specific medium may include a specific Internet site, a TV home shopping service, an IPTV, an Internet UCC, etc. This enables the seller and the buyer to recognize and participate in the goods sale contest in real time through a TV or the Internet. Also, the goods sale contest result can be advertised through the medium to maximize advertisement effects.

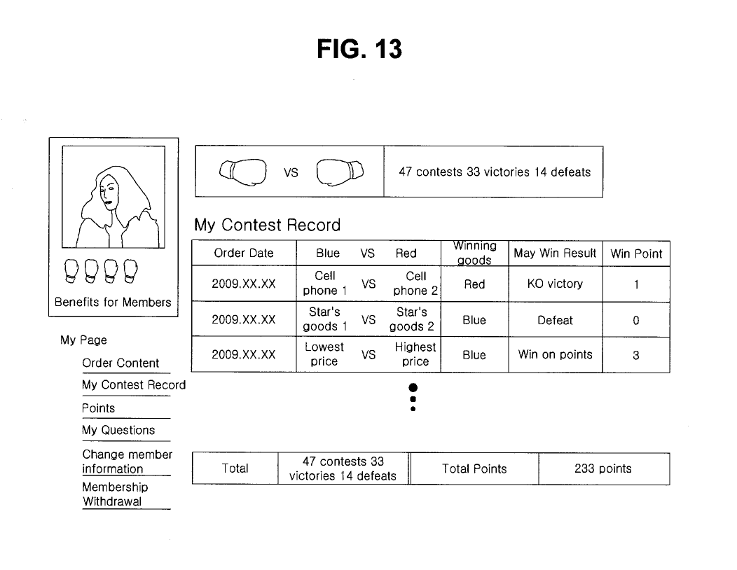

FIG. 13 illustrates a screen for management of a contest record for each person according to an exemplary embodiment of the present invention.

As shown in FIG. 13, the screen for contest record management according to the present invention may be provided for each person. The screen enables a seller or a buyer to confirm his or her contest record by logging in to a corresponding webpage with his or her ID. The contest record on the webpage may be provided according to a sale date or order date.

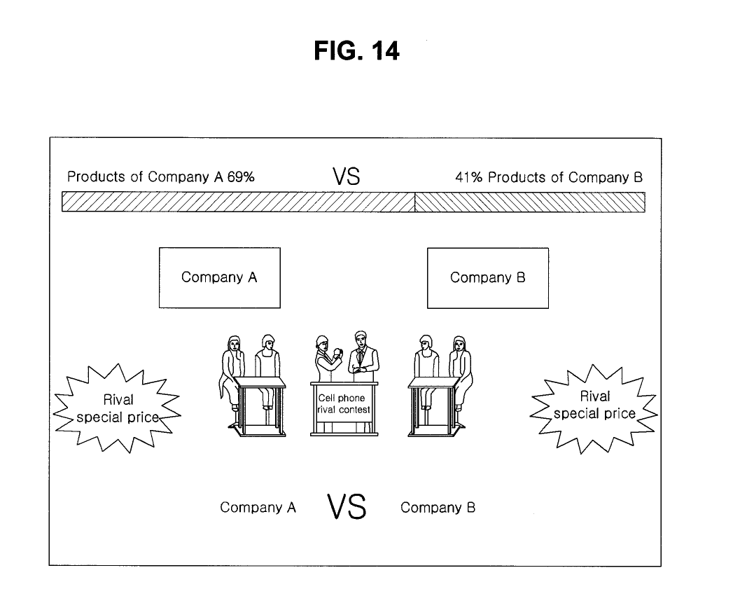

FIG. 14 illustrates a screen for broadcasting of a 1:1 goods sale contest in a TV home shopping service according to an exemplary embodiment of the present invention.

As shown in FIG. 14, a goods sale contest through a TV home shopping service according to the present invention may be implemented as a 1:1 contest. The TV home shopping service may proceed live. A contest proceeding time may vary with cooperation with a home shopping company.

The goods sale contest may be requested by sellers. For example, a first seller may propose the sale contest to a home shopping manager for brands or goods of a second seller when requesting the contest. The home shopping manager then delivers the proposal to the second seller. When the second seller accepts the proposal, the 1:1 goods sale contest may proceed.

Meanwhile, the 1:1 goods sale contest may be requested by the home shopping manager or the buyer (including a viewer). For example, the home shopping manager or the buyer may recommend the goods sale contest for two brands or goods. The home shopping manager proposes the contest to sellers of the recommended brands or goods. When the sellers accept the proposal, the goods sale contest may proceed.

The goods sale contest implemented through the TV home shopping service may be implemented as a survival consecutive-victory contest and a tournament contest by consecutively proceeding with a 1:1 sale contest. A contest result may be determined according to a total order amount or a total sale amount. For example, the contest result may be determined as a win on points for different total sale amounts, a KO victory for early sell-out, and a tie for the same total order amounts or total sale amounts. The contest may further include a consolation contest and a return contest.

Benefits may then be given to buyers purchasing goods of the winning seller in the 1:1 goods sale contest. The benefits may include mileage and reservation of reserve-funds, discounts, and coupons. In addition, the winning seller may be provided with a winning bonus. The winning bonus may include a discounted sale commission and an advertisement priority. A rate of reserving reserve-funds for the buyer and a commission discount rate for the seller may be differently applied according to the contest result.

For the goods sale contest through the TV home shopping service, a show host may proceed with and mediate the goods sale contest. Each seller participates as a guest to provide details of products for sale in the home shopping service.

Thus, the goods sale contest through the TV home shopping service according to the present invention enables buyers to recognize goods information and a situation of the goods sale contest in real time and to participate in the contest.

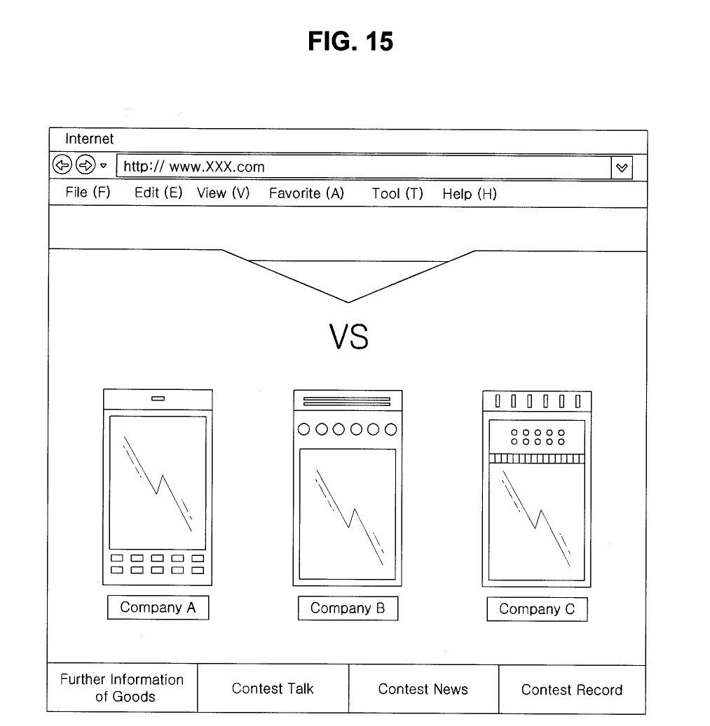

FIG. 15 illustrates a screen for broadcasting of a multi-party goods sale contest in an Internet shopping service according to an exemplary embodiment of the present invention.

As shown in FIG. 15, a multi-party goods sale contest according to the present invention may be implemented through an Internet shopping service.

When a request for a multi-party goods sale contest is received and the multi-party goods sale contest is established, a plurality of sellers in the multi-party goods sale contest proceed with the multi-party goods sale contest.

A mediator then analyzes a sale result in consideration of a sale record after a predetermined sale time lapses. The mediator may be a server for managing IPTV broadcasting. Alternatively, the mediator may be a separate show host who proceeds with the multi-party goods sale contest broadcasted through an IPTV.

The mediator then determines a sale rank of the plurality of sellers, based on the analyzed sale result. The sale rank of the sellers may be determined based on a total order amount or a total sale amount.

The mediator may then give different benefits to buyers purchasing the goods of the plurality of sellers according to the sale rank. The benefits may include mileage and reservation of reserve-funds, discounts, and coupons.

In addition, the mediator may give a predetermined winning bonus corresponding to the rank to the plurality of sellers. The winning bonus may include benefits such as a discounted sale commission and an advertisement priority. For example, the mediator may give the benefits such as a discounted sale commission and an advertisement priority to high ranked sellers according to the rank. On the other hand, the mediator may give penalties such as sale restriction during a predetermined period or a relatively higher commission rate to low ranked sellers.

In other exemplary embodiments of the present invention, the multi-party sale contest may be implemented by a wired/wireless Internet shopping service, an IPTV shopping service, or a TV home shopping service. The wireless Internet shopping service may be implemented through mobile devices, such as cell phones, personal digital assistants (PDAs), smart phones, and Net-books.

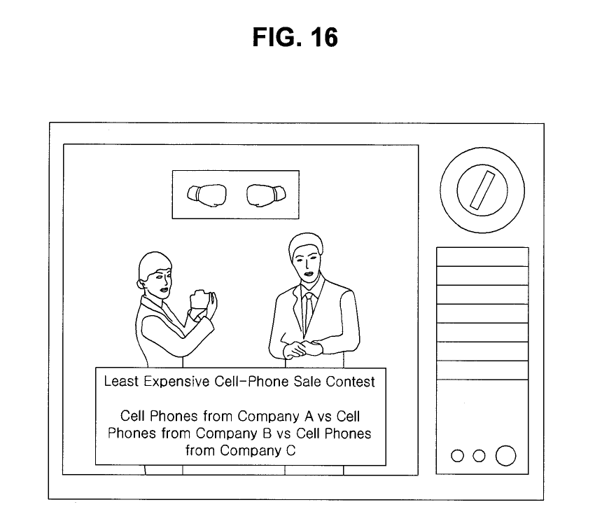

FIG. 16 illustrates a screen for broadcasting of a multi-party goods sale contest in a TV home shopping service according to an exemplary embodiment of the present invention.

As shown in FIG. 16, a multi-party goods sale contest according to the present invention may be implemented through a TV home shopping service. The multi-party goods sale contest through the TV home shopping service may proceed live. Details of the multi-party goods sale contest may vary with cooperation with a TV home shopping company.

When the multi-party goods sale contest is established in response to a request for the contest, a plurality of sellers in the multi-party goods sale contest proceed with the multi-party goods sale. The multi-party goods sale contest may be requested by at least one of the plurality of sellers. For example, when there are six sellers, a first seller may write five goods sellers or five brands to a multi-party goods sale contest item when requesting the contest to the home shopping manager. The home shopping manager may then deliver the request for a goods sale contest to the other five sellers. If the five sellers accept the request for a goods sale contest, the multi-party goods sale contest may proceed.

Meanwhile, the multi-party goods sale contest may be requested by a home shopping manager or a buyer (including a viewer). For example, the home shopping manager or the buyer may recommend a goods sale contest for several brands or goods. The home shopping manager may then propose the multi-party goods sale contest to sellers of the recommended brand or goods. When the sellers accept the proposal, the multi-party goods sale contest may proceed.

When the multi-party goods sale contest proceeds and a predetermined time lapses, the home shopping manager may analyze the sale result in consideration of sale amounts of the respective sellers. The sale result may be analyzed by a separate show host proceeding with the multi-party goods sale contest through the TV home shopping service.

The home shopping manager may determine a sale rank of the plurality of sellers based on the analyzed sale result. The sale rank of the sellers may be determined based on a total order amount or a total sale amount.

Different benefits may be given to buyers purchasing the goods of the plurality of sellers according to the sale rank. The benefits may include mileage and reservation of reserve-funds, discounts, and coupons. In addition, a predetermined winning bonus corresponding to the sale rank may be given to the plurality of sellers. The winning bonus may include benefits such as a discounted sale commission and an advertisement priority. In this case, penalties such as sale restriction during a predetermined period or a relatively higher commission rate may be given to low ranked order sellers.

As described above, with the method for providing a shopping mall and a server system therefore according to the present invention, at least one of 1:1 contest and a multi-party goods sale contest among at least three sellers is performed and separate benefits are given to buyers purchasing goods of a winning seller in the sale contest, thereby inducing positive purchase by the buyers.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. (canceled)

2. A server system for providing a virtual shopping mall over a network, comprising:
a server comprising:
a controller for receiving a request for a sales contest from a terminal of a recommender, the terminal being connected to the network; selecting at least two sellers based on the request; transmitting proposals of the sales contest to the selected sellers; receiving acceptances of the proposals from the selected sellers; initiating an online sales contest according to the request; determining a contest result based on a number of sales after a predetermined time; and determining a winning seller and winning buyers based on the contest result, wherein the controller provides rewards to the winning buyers based on the contest result;
a database for storing the contest result, the database being connected to the controller; and
a display unit for displaying a current result of the online sales contest to buyers during the online sales contest and a final result of the online sales contest including win or defeat on the online sales contest after the predetermined time to buyers.

3. The server system of claim 2, wherein the sales contest is one of a 1:1 contest and a multi-party contest.

4. The server system of claim 3, wherein for the multi-party contest, the controller determines sales ranks of the sellers based on the number of sales, wherein contest rewards are given to buyers purchasing goods from the sellers according to the sales ranks.

5. The server system of claim 2, wherein the contest rewards comprise at least one of mileage and reservation of reserve-funds, discounts, and coupons to the buyers.

6. The server system of claim 2, wherein a predetermined winning bonus is given to the determined winning seller.

7. The server system of claim 6, wherein the winning bonus comprises at least one of a discounted sales commission and an advertisement priority to the winning seller.

8. The server system of claim 2, wherein the server further comprises a communication unit for transmitting the current result of the online sales contest to a medium connected to the network during the online sales contest, wherein the medium comprises at least one of a TV home shopping network, an IPTV, Internet UCC and a media organization's server.

9. The server system of claim 2, wherein the virtual shopping mall is at least one of a wired or wireless Internet shopping mall, an IPTV shopping mall, and a TV home shopping mall.

10. A method for providing a virtual shopping mall over a network using a server comprising a controller, a database, a display unit, and a communication unit, the method comprising the steps of:
receiving, by the controller, a request for a sales contest from a terminal of a recommender, the terminal being connected to the network;
selecting, by the controller, at least two sellers based on the request;
transmitting, by the controller, proposals of the sales contest to the selected sellers;
receiving, by the controller, acceptances of the proposals from the selected sellers;
initiating, by the controller, an online sales contest according to the request;
determining, by the controller, a contest result based on a number of sales after a predetermined time;
determining, by the controller, a winning seller and winning buyers based on the contest result;
providing, by the controller, rewards to the winning buyers based on the contest result;
storing, by the database, the contest result; and
displaying, by the display unit, a current result of the online sales contest to buyers during the online sales contest and a final result of the online sales contest including win or defeat on the online sales contest after the predetermined time to buyers.

11. The method of claim 10, wherein the sales contest is one of a 1:1 contest and a multi-party contest.

12. The method of claim 11, wherein for the multi-party contest, the controller determines sales ranks of the sellers based on the number of sales, wherein contest rewards are given to buyers purchasing goods from the sellers according to the sales ranks.

13. The method of claim 10, wherein the contest rewards comprise at least one of mileage and reservation of reserve-funds, discounts, and coupons to the buyers.

14. The method of claim 10, further comprising the step of providing, by the controller, a predetermined winning bonus to the determined winning seller.

15. The method of claim 14, wherein the winning bonus comprises at least one of a discounted sales commission and an advertisement priority to the winning seller.

16. The method of claim 10, further comprising the step of transmitting, by the communication unit, the current result of the online sales contest to a medium connected to the network during the online sales contest, wherein the medium comprises at least one of a TV home shopping network, an IPTV, Internet UCC and a media organization's server.

17. The method of claim 10, wherein the virtual shopping mall is at least one of a wired or wireless Internet shopping mall, an IPTV shopping mall, and a TV home shopping mall.
